(19) United States
(12) Patent Application Publication
(10) Pub. No.: US 2026/0117077 A1
(43) Pub. Date: Apr. 30, 2026

(54) BINDER SYSTEM FOR AN AQUEOUS STOVING PAINT

(71) Applicant: BASF SE, Ludwigshafen am Rhein (DE)

(72) Inventors: Chintankumar Jayantilal PATEL, Ludwigshafen am Rhein (DE); Rainer ERHARDT, Ludwigshafen am Rhein (DE)

(21) Appl. No.: 19/115,720

(22) PCT Filed: Sep. 22, 2023
(86) PCT No.: PCT/EP2023/076296

§ 371 Date: Mar. 26, 2025

(30) Foreign Application Priority Data
Sep. 27, 2022 (EP) 22198075.8

(51) Int. Cl. C09D 5/18; C09D 5/02; C09D 133/04

(52) U.S. Cl. CPC C09D 5/18; C09D 5/022; C09D 133/04

(57) ABSTRACT

The present invention relates to the use of a binder system (B) in an aqueous stoving paint composition, wherein said a binder system (B) comprises
(a) an aqueous dispersion of polymer P and
(b) from 1 to 10% by weight based on the amount of polymer P of at least one amine and/or amide having at least two hydroxyl groups,
wherein said aqueous dispersion of the polymer P is prepared by a free-radically initiated emulsion polymerization of ethylenically unsaturated monomers M

| | |
|---|---|
| 90% to 99% | of styrene, C₁-C₆-alkyl methacrylate and/or cyclohexyl |
| by weight | methacrylate, preferably of styrene and/or C₁-C₆-alkyl |
| | methacrylate;; |
| 1% to 10% | of one or more monoethylenically unsaturated carboxylic |
| by weight | acid, hydroxy(C₂-C₄)-alkyl (meth)acrylate and/or |
| | glycidyl(meth)acrylate, |
| 0% and to 9% | of C₄-C₁₀-alkyl acrylate, and |
| by weight | |

where the amounts of the monomers M add up to 100% by weight,

in an aqueous medium in the presence of a polymer A, having the following monomeric structural units:

| | |
|---|---|
| 70 to 95% | of one or more ethylenically unsaturated mono- and/or |
| by weight | dicarboxylic acid, |
| 5 to 30% | of at least one of esters of ethylenically unsaturated mono- |
| by weight | carboxylic acids, monoesters of ethylenically unsaturated di- |
| | carboxylic acids and diesters of ethylenically unsaturated di- |
| | carboxylic acids wherein each ester is obtained by esterify- |
| | ing with an amine having at least one hydroxyl group, and |
| 0 to 20% | of at least one further monomers; |
| by weight | |

the amount being based in each case on the total amount of all
monomeric structural units in the polymer A,

aqueous stoving paint composition itself, a method of applying the stoving paint composition to a metallic surface or a precoated metallic surface and the coated metallic articles.

The present invention relates to the use of a binder system (B) in an aqueous stoving paint composition, wherein said binder system (B) comprises
(a) an aqueous dispersion of polymer P and
(b) from 1 to 10% by weight based on the amount of polymer P of at least one amine and/or amide having at least two hydroxyl groups,
the stoving paint and a method of applying a coating to a surface using the binder system (B) and the coated article.

The use of heat-curable coating materials as a protective coating or protective paint for materials such as steel strips is prior art. An ideal protective coating adheres well to the undersurface, is simultaneously hard and flexible, and is resistant to weathering, solvents, abrasion and heat. It is difficult to achieve an optimum for all of these properties, as the improvement of one property is in most cases at the expense of the others. A high elasticity and adhesion are desirable especially during the processing and shaping of already painted metal strips, in order to prevent an exfoliation of the protective coating at the angled parts. At the same time the protective coating should be hard enough to be resistant to mechanical influences.

Stoving paints in general are heat-curable coating materials that chemically harden under increased heat supply. In terms of technology there are so-called powder coatings, which are 100% solid and powdery in nature and which are competing with liquid paint. Liquid paint can be solvent-based or water-based. Water-based paint are preferred due to lower VOC (volatile organic carbon) content. Curing temperatures for all above mentioned technologies are similar and around 150° C.

The most common liquid binder systems for such heat-curable coating materials are polyesters and polyacrylates, which are thermally crosslinked with melamine formaldhyde resins, for example. Known per se cross-linking agents containing N-methylol groups such as aminoplastics, which are reaction products of formaldehyde with for example, urea, dicyandiamide and aminotriazines, for example melamine.

All of these systems release formaldehyde during crosslinking. Therefore, new “formaldehyde-free” systems have been sought for a long time or stoving paints that cure at temperatures around 150° C. within 15 minutes.

It is an object of the invention to provide a new formaldehyde-free binder system to use in in aqueous stoving paints. It is further an object of the invention to provide substrates produced using a binder system of this kind.

Furthermore, the hardened stoving paints produced with this binder system should have a good elasticity, good adhesion on the substrate, high gloss, excellent surface hardness and good water resistance.

We have found that these objects are achieved, surprisingly, by the use of a binder system (B) in an aqueous stoving paint composition, wherein said binder system (B) comprises
(a) an aqueous dispersion of polymer P and
(b) from 1 to 10% by weight based on the amount of polymer P of at least one amine and/or amide having at least two hydroxyl groups,
wherein said aqueous dispersion of the polymer P is prepared by a free-radically initiated emulsion polymerization of ethylenically unsaturated monomers M

| | |
|---|---|
| 90% to 99% by weight | of styrene, C₁-C₆-alkyl methacrylate and/or cyclohexyl meth- |
| | acrylate, preferably of styrene and/or C₁-C₆-alkyl methacry- |
| | late; |
| 1% to 10% by weight | of one or more monoethylenically unsaturated carboxylic |
| | acid, hydroxy(C₂-C₄)-alkyl (meth)acrylate and/or glyc- |
| | idyl(meth)acrylate, |
| 0% and to 9% by weight | of C₄-C₁₀-alkyl acrylate, and |

where the amounts of the monomers M add up to 100% by weight,

in an aqueous medium in the presence of a polymer A, having the following monomeric structural units:

| | |
|---|---|
| 70 to 95% by weight | of one or more ethylenically unsaturated mono- and/or dicar- |
| | boxylic acid, |
| 5 to 30% by weight | of at least one of esters of ethylenically unsaturated mono- |
| | carboxylic acids, monoesters of ethylenically unsaturated di- |
| | carboxylic acids and diesters of ethylenically unsaturated di- |
| | carboxylic acids wherein each ester is obtained by esterify- |
| | ing with an amine having at least one hydroxyl group, and |
| 0 to 20% by weight | of at least one further monomer; |

the amount being based in each case on the total amount of all monomeric structural units
in the polymer A.

The present invention further relates to the aqueous stoving paint composition itself, a method of applying the stoving paint composition to a metallic surface or a precoated metallic surface and the coated metallic articles.

If the solids content of the aqueous dispersion in wt % is mentioned, it is based on the weight of the aqueous dispersion.

In the following, compounds derived from acrylic acid and methacrylic acid are partly shortened by inserting the syllable “(meth)” in the compound derived from the acrylic acid.

Polymer P is prepared by a free-radically initiated emulsion polymerization of ethylenically unsaturated monomers M

| | |
|---|---|
| 90% to 99% by weight | of styrene, C₁-C₆-alkyl methacrylate and/or cyclohexyl methacry- |
| | late, preferably of styrene and/or C₁-C₆-alkyl methacrylate; |
| 1% to 10% by weight | of one or more monoethylenically unsaturated carboxylic acid, hy- |
| | droxy(C₂-C₄)-alkyl (meth)acrylate and/or glycidyl(meth)acrylate; |
| 0% and to 9% by weight | of C₄-C₁₀-alkyl acrylate, and |

where the amounts of the monomers M add up to 100% by weight,
in the presence of the polymer A.

In connection with the monomer components of the polymer P, alkyl below is preferably straight-chain or branched C₁-C₆ alkyl groups or C₄-C₁₀ alkyl groups, such as methyl, ethyl, n-propyl, n-butyl, sec-butyl, tert-butyl, n-pentyl, n-hexyl, 2-ethylhexyl.

The polymer P is formed from styrene, C₁-C₆-alkyl methacrylate and/or cyclohexylmethacrylate as principal monomer. Particularly preferred principal monomers are styrene, methyl methacrylate, cyclohexyl methacrylate and n-butyl methacrylate, especially styrene and methyl methacrylate.

The comonomer is selected from of one or more monoethylenically unsaturated carboxylic acid, hydroxy(C₂-C₄)-alkyl (meth)acrylate and/or glycidyl(meth)acrylate and C₄-C₁₀-alkyl acrylate.

Suitable monoethylenically unsaturated carboxylic acid are C₃-C₆ α,β-monoethylenically unsaturated monocarboxylic acid, such as acrylic acid and methacrylic acid. If desired, these acids may also be present partly or fully in the form of a salt in the polymer. The acidic form is preferred.

Suitable hydroxy(C₂-C₄)-alkyl (meth)acrylates are 2-hydroxyethyl acrylate, 2-hydroxyethyl methacrylate, hydroxypropyl acrylate, hydroxypropyl methacrylate, hydroxybutyl acrylate. Very particular preference is given to 2-hydroxyethyl acrylate and 2-hydroxyethyl methacrylate.

Preferably the C₄ to C₁₀-alkyl acrylate is selected from the group consisting of n-butyl acrylate and 2-ethylhexyl acrylate.

Preferably polymer P is prepared by polymerization of monomers M

| | |
|---|---|
| 90% to 99% by weight | of styrene, C₁-C₄-alkyl methacrylate and/or cyclohexyl methacrylate, |
| | preferably of styrene and/or C₁-C₄-alkyl methacrylate; |
| 1% to 10% by weight | of one or more monoethylenically unsaturated carboxylic acid, 2-hy- |
| | droxyethyl acrylate and/or 2-hydroxyethyl methacrylate, |
| 0% and to 9% by weight | of C₄-C₁₀-alkyl acrylate; and |

where the amounts of the monomers M add up to 100% by weight.

The polymer A, has the following monomeric structural units:

| | |
|---|---|
| 70 to 95% | of one or more ethylenically unsaturated mono- and/or |
| by weight | dicarboxylic acid, preferably acrylic acid and maleic |
| | acid |
| 5 to 30% | of at least one of esters of ethylenically unsaturated |
| by weight | monocarboxylic acids, monoesters of ethylenically |
| | unsaturated dicarboxylic acids and diesters of |
| | ethylenically unsaturated dicarboxylic acids wherein |
| | each ester is obtained by esterifying with an amine |
| | having at least one hydroxyl group, and |
| up to 20% | of at least one further monomer; |
| by weight | |

the amount being based in each case on the total amount of all monomeric structural units in the polymer A.

Such polymers A and their preparation is generally known and described, for example, in U.S. Pat. No. 6,841,608. The polymer A is preferably soluble in water to the extent of more than 10 g/l (25° C.).

Ethylenically unsaturated carboxylic acids are C₃ to C₁₀ monocarboxylic acids and C₄ to C₈ dicarboxylic acids, especially acrylic acid, methacrylic acid, crotonic acid, fumaric acid, maleic acid, 2-methylmaleic acid and/or itaconic acid. Particular preference is given to acrylic acid, methacrylic acid, maleic acid and mixtures thereof. In the preparation of the polymer A it is of course also possible to use, instead of or together with the acids, their anhydrides, such as maleic anhydride, acrylic anhydride or methacrylic anhydride. If desired, these acids may also be present partly or fully in the form of a salt in the polymer. The acidic form is preferred.

The polymer A further contains from 5 to 30% by weight, preferably from 1 to 30% by weight, monomeric structural units of at least one ethylenically unsaturated compound selected from esters of ethylenically unsaturated monocarboxylic acids and monoesters and diesters of ethylenically unsaturated dicarboxylic acids with an amine having at least one hydroxyl group, in copolymerized form.

The polymer A is preferably in the form of a comb polymer having covalently bonded amine side chains.

Monocarboxylic acids suitable as components of the esters are the abovementioned C₃ to C₁₀ monocarboxylic acids, especially acrylic acid, methacrylic acid, crotonic acid and mixtures thereof. Dicarboxylic acids suitable as components of the monoesters and diesters are the abovementioned C₄ to C₈ dicarboxylic acids, especially fumaric acid, maleic acid, 2-methylmaleic acid, itaconic acid, and mixtures thereof. Preferred are acrylic acid, maleic acid and mixtures thereof.

The amine having at least one hydroxyl group is preferably selected from secondary and tertiary amines containing at least one C₆ to C₂₂ alkyl, C₆ to C₂₂ alkenyl, aryl-C₆ to C₂₂ alkyl or aryl-C₆ to C₂₂ alkenyl radical, it being possible for the alkenyl group to have 1, 2 or 3 nonadjacent double bonds.

The amine having at least one hydroxyl group is preferably a fatty amine, preferably selected form the group 1-octylamine, 1-decylamine, 1-dodecylamine, 1-tetradecylamine, 1-hexadecylamine, 1-octadecylamine and 1-eicosylamine.

The amine is preferably hydroxyalkylated and/or alkoxylated. Alkoxylated amines preferably have one or two alkylene oxide residues with terminal hydroxyl groups. Preferably, the alkylene oxide residues each have from 1 to 100, preferably from 1 to 50, identical or different alkylene oxide units, distributed randomly or in the form of blocks. Preferred alkylene oxides are ethylene oxide, propylene oxide and/or butylene oxide. Ethylene oxide is particularly preferred.

With particular preference, the amine component comprises an alkoxylated fatty amine or an alkoxylated fatty amine mixture. The ethoxylates are particularly preferred. Use is made in particular of alkoxylates of amines based on naturally occurring fatty acids, such as tallow fatty amines, for example, which contain predominantly saturated and unsaturated C₁₄, C₁₆ and C₁₈ alkylamines, or cocoamines, containing saturated, mono- and diunsaturated C₆-C₂₂ alkylamines preferably C₁₂-C₁₄ alkylamines.

Examples of suitable commercially available alkoxylated amines are the Noramox® grades from Arkema, preferably ethoxylated oleyl-amines, such as Noramox 05 (5 EO units), and the products from BASF SE marketed under the brand name Lutensol® FA.

Copolymerization of the abovementioned esters, monoesters and diesters generally brings about pronounced stabilization of the polymer dispersion of the invention. The polymer dispersions of the invention reliably retain their colloidal stability of the latex particles on dilution with water or dilute electrolytes or surfactant solutions.

The esterification for preparing the above-described esters, monoesters and diesters takes place in accordance with customary techniques known to the skilled worker.

In one preferred embodiment, the unsaturated esters, monoesters or diesters are prepared and further reacted to the polymers A used in accordance with the invention without isolation of the esters, the two reactions preferably taking place in succession in the same reaction vessel.

To prepare the polymers A it is preferred to use a reaction product of a dicarboxylic anhydride, preferably maleic anhydride, and one of the above-described hydroxyl-containing amines.

In addition to the carboxylic acid and the ester, monoester and/or diester constituents, the polymer A may also contain up to 20% by weight, preferably from 0.1 to 10% by weight, of further monomeric structural unit neither being a unit of ethylenically unsaturated mono- and/or dicarboxylic acid, nor of esters of ethylenically unsaturated monocarboxylic acids, mono- or diesters of ethylenically unsaturated dicarboxylic acids with an amine having at least one hydroxyl group.

Further monomeric structural units are in copolymerized form the monomers specified for example in connection with polymer P. Particular preference being given to vinylaromatic monomers, such as styrene, olefins, examples being ethylene, or (meth)acrylic esters such as methyl (meth)acrylate, ethyl (meth)acrylate, n-butyl (meth)acrylate, 2-ethylhexyl (meth)acrylate, and mixtures thereof.

The polymers A are prepared preferably by free-radical polymerization in bulk or in solution as described in U.S. Pat. No. 6,841,608.

The polymers A may advantageously also be prepared by means of polymer-analogous reaction. For this purpose a polymer incorporating from 80 to 100% by weight of at least one ethylenically unsaturated mono- and/or dicarboxylic acid and from 0 to 20% by weight of the abovementioned other polymers may be reacted with at least one hydroxyl-containing amine.

The proportion of structural units is calculated and is based on the assumption that all monomers are converted to the polymer (100% conversion). In the case of the polymer-analogous reaction, the calculation of the weight fraction of the ester is based on the assumption that the amine having at least one hydroxyl group is completely esterified. Furthermore, it is assumed that in the case of the presence of a dicarboxylic acid, the half-ester is formed.

The polymers P are prepared preferably by free-radical polymerization in an aqueous medium in the presence of the polymer A, as described in U.S. Pat. No. 6,841,608. The aqueous dispersion of polymer P is prepared by aqueous emulsion polymerization, a batchwise, semicontinuous or continuous procedure being possible. Preferably, beside polymer A no additional emulsifiers are added to stabilize the emulsion.

The polymerization is conducted in the presence of compounds which form free radicals (initiators). These may be peroxides, azo compounds. Or redox initiator systems. All these types of initiators are well known to the skilled person in the art and are described for example in U.S. Pat. No. 6,841,608. The amount required of these initiators is preferably from 0.05 to 10, with particular preference from 0.2 to 5% by weight, based on the monomers used in the polymerization.

The initiators can be employed alone or in a mixture with one another, examples being mixtures of hydrogen peroxide and sodium peroxodisulfate. For polymerization in an aqueous medium it is preferred to use water-soluble initiators.

In order to prepare polymers having a low average molecular weight it is often judicious to conduct the copolymerization in the presence of regulators (free-radical chain transfer agent). Customary regulators can be used for this purpose, examples being organic compounds containing SH groups, such as 2-mercaptoethanol, 2-mercaptopropanol, mercaptoacetic acid, tert-butyl mercaptan, n-octyl mercaptan, n-dodecyl mercaptan and tert-dodecyl mercaptan, hydroxylammonium salts such as hydroxylammonium sulfate, formic acid, sodium bisulfite, or isopropanol. The polymerization regulators are generally used in amounts of from 0.05 to 5% by weight, based on the monomers.

In order to prepare copolymers of relatively high molecular weight it is often judicious to conduct the polymerization in the presence of crosslinkers. Such crosslinkers are compounds having two or more ethylenically unsaturated groups, such as, for example, diacrylates or dimethacrylates of at least dihydric saturated alcohols, examples being ethylene glycol diacrylate, ethylene glycol dimethacrylate, 1,2-propylene glycol diacrylate, 1,2-propylene glycol dimethacrylate, 1,4-butanediol diacrylate, 1,4-butanediol dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylic and methacrylic esters of alcohols having more than 2 OH groups can also be used as crosslinkers, an example being trimethylolpropane triacrylate or trimethylolpropane trimethacrylate.

The weight ratio of polymer P to polymer A, based on solids, is preferably in the range from 4:1 to 1:4, in particular from 3:1 to 1:3.

The binder system (B) according to the present invention further comprises from 1 to 10% by weight based on the amount of polymer P of at least one amine and/or amide having at least two hydroxyl groups.

Suitable amines having at least two hydroxyl groups are alkoxylated, preferably ethoxylated or propoxylated, alkylamine. According to one embodiment these alkylamines are alkylamines, which are also present in the polymer A in esterified form. The alkoxylated alkylamines present in the polymer A, and the additional alkylamine (b), may be identical or different compounds. Suitable amine and/or amide having at least two hydroxyl groups are the alkanolamines disclosed in DE 197 29 161, which are hereby made part of the disclosure content of the present invention by reference.

Preferred amines are β-hydroxyalkylamines of the formula

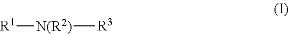

where R¹ is a hydrogen atom, a C₁ to C₁₀ alkyl group, a C₁ to C₁₀ hydroxyalkyl group, or a radical of the formula II

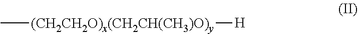

where
in the formula II the sequence of the alkylene oxide units is arbitrary and x and y independently of one another are integers from 0 to 100, the sum of x and y being >1, and R² and R³ independently of one another are a C₁ to C₁₀ hydroxyalkyl group.

With particular preference, R² and R³ independently of one another are a C₂ to C₈ hydroxyalkyl group and R¹ is a hydrogen atom, a C₁ to C₈ alkyl group or a C₂ to C₈ hydroxyalkyl group.

Particular preference is given to diethanolamine, triethanolamine, diisopropanolamine, triisopropanolamine, methyldiethanolamine, butyldiethanolamine and methyldiisopropanolamine, especially triethanolamine.

Further preferred β-hydroxyalkylamines are the amines disclosed as component A in DE 196 21 573, which is hereby made part of the disclosure content of the present invention by reference. They include preferably linear or branched aliphatic compounds containing per molecule at least two functional amino groups which are alkoxylated.

Preferred β-hydroxyalkylamines of relatively high functionality are, in particular, at least doubly ethoxylated amines having a molar weight of less than 1000 g/mol, such as diethanolamine, triethanolamine and ethoxylated diethylenetriamine, for example, preferably stoichiometrically ethoxylated diethylenetriamine, i.e., diethylenetriamine, in which on average all NH hydrogen atoms are monoethoxylated.

Further preferred are amide having at least two hydroxyl groups. Suitable amide include β-hydroxyalkylamides, preferably the β-hydroxyalkylamides specified in U.S. Pat. No. 5,143,582, of the formula III

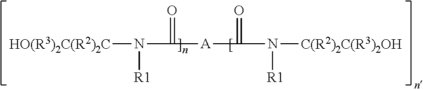

Particularly preferred β-hydroxyalkylamides of the above formula are those in which R¹ is hydrogen, a short-chain alkyl group, or HO(R³)₂C(R²)₂C—, n and n′ are each 1, -A- is a (CH₂)ₘ— group, m is from 0 to 8, preferably from 2 to 8, R² in each case is hydrogen, and in each case one of the R³ groups is hydrogen and the other is hydrogen or C₁-C₅ alkyl. Bis[N,N-di(2-hydroxyethyl)]adipamide is particularly preferred.

The addition of the amine having at least two hydroxyl groups, generally brings about better curing of the compositions of the invention at a given curing temperature, or, respectively, curing at low temperature for a given curing time. The weight fraction of the amine, relative to the sum of polymer P and A is from 0 to 30% by weight, preferably from 0.1 to 15% by weight.

In addition, a reaction accelerant may be added to the polymer dispersions of the invention. Preferred such accelerants are phosphorus compounds, especially hypophosphorous acid and its alkali metal salts and alkaline earth metal salts, or alkali metal tetrafluoroborates. Further reaction accelerants which may be added include salts of Mn(II), Ca(II), Zn(II), Al(III), Sb(III) or Ti(IV), or strong acids, such as para-toluenesulfonic acid, trichloroacetic acid and chlorosulfonic acid. The weight fraction of the reaction accelerant relative to the sum of polymer P and A is from 0.1 to 5% by weight, preferably from 0.1 to 2% by weight.

Particularly preferred compositions of the binder system of the invention are as follows:
from 70 to 50% by weight of polymer P,
from 30 to 50% by weight of polymer A and, if desired,
from 0 to 10% by weight of surface-active alkoxylated alkylamine,
from 1 to 10% by weight of amine and/or amide having at least two hydroxyl groups,
from 0 to 5% by weight of reaction accelerant.

The binder system of the invention essentially comprises finely divided emulsion polymer particles of P and an aqueous phase comprising the polymer A and, separately added one amine and/or amide having at least two hydroxyl groups. It is possible that it further comprises amine not reacted during the production of polymer A.

Where the aforementioned binder system (B) is used for producing an aqueous stoving paint composition, the aqueous stoving paint composition may additionally comprise pigments, fillers, dispersants, thickeners, preservatives, film-forming assistants, flow control and wetting assistants, solvents, neutralizing agents, defoamers, light stabilizers and/or corrosion inhibitors.

The invention further provides an aqueous stoving paint composition comprising
(a) the binder system (B) according to the invention
(b) one or more defoamer
(c) optionally one or more coalescing agents
(d) optionally one or more pigments and/or fillers
(e) optionally one or more other additives
(f) optionally one or more polyurethane dispersions with sulfonic acid groups,

Preferably any of pigments and fillers present in the aqueous stoving paint composition has a particle size of not more than 50 μm according to DIN EN ISO 1524.

Defoamers are low surface-tension liquids that have a controlled insolubility or incompatibility in the system to be defoamed, along with positive penetration and a positive spreading coefficient (Mannari, Patel, Understanding Coatings Raw Materials, Vincentz Verlag 2015, pp. 254). The effect of such liquid defoamers can be boosted by adding finely dispersed hydrophobic particles, which help in destabilization by reducing the cohesive forces. The main groups of defoamers for waterbased coatings are: mineral oilbased defoamers, silicone defoamers and fluorinated defoamers.

Coalescing agents will be apparent to those skilled in the art. Non-exclusive examples of coalescing agents include monoethers and monoesters of glycols, preferably glycols with at least one terminal hydroxy group. Monoethers of ethylene glycol are readily available. Monoethers of propylene glycol, particularly the methyl, t-butyl, n-butyl, and phenol monoethers of propylene glycol, dipropylene glycol and tripropylene glycol are preferred from this class.

Pigments which can be used in this context include in principle all organic and/or inorganic white and/or chromatic pigments familiar to a person skilled in the art and having a particle size ≤10 000 nm (Brock, Groteklaes, Mischke, Lehrbuch der Lacktechnologie 2nd edition, Ed. U. Zorll, Vincentz Verlag 1998, p. 113).

The most important white pigment for mention, on account of its high refractive index (rutile: 2.70 and anatase: 2.55) and its high hiding power, is titanium dioxide in its various modifications. However, zinc oxide and zinc sulfide as well are used as white pigments. These white pigments may be used in surface-coated or uncoated form. In addition, however, use is also made of organic white pigments, such as, for example, nonfilming hollow polymer particles of high styrene and carboxyl group content, having a particle size of around 300 to 400 nm (referred to as opaque particles).

In addition to white pigments, a very wide variety of chromatic pigments familiar to a person skilled in the art may be used for providing color, examples being the relative inexpensive inorganic iron, cadmium, chromium, and lead oxides and sulfides, lead molybdate, cobalt blue or carbon black, and also the relatively expensive organic pigments, examples being phthalocyanines, azo pigments, quinacridones, perylenes or carbazoles.

Optionally or in addition the pigments, the aqueous stoving paint composition may of course further comprise fillers, as they are known, which are familiar to a person skilled in the art. Fillers are understood essentially to be inorganic materials in powder form with a particle size ≤10 000 nm (Brock, Groteklaes, Mischke, Lehrbuch der Lacktechnologie 2nd edition, Ed. U. Zorll, Vincentz Verlag 1998, p. 113) having a refractive index lower by comparison with the pigments (white fillers according to DIN 55943 and DIN 55945 have refractive index values <1.7). The fillers in powder form here are often naturally occurring minerals, such as, for example, calcite, chalk, dolomite, kaolin, talc, mica, diatomaceous earth, baryte, quartz or talc/chlorite intergrowths, and also synthetically prepared inorganic compounds, such as, for example, precipitated calcium carbonate, calcined kaolin or barium sulfate, and also fumed silica. A preferred filler used is barium sulfate.

Optionally the aqueous stoving paint composition may comprise other additives e) for example, flow-control agents, antisettling agents, antioxidants, UV stabilizers, rheology modifier, plasticizers, gloss improvers, wetting agents, waxes and catalysts, which contribute to the attainment of high-quality covering layers.

Corrosion inhibitors or flash rust inhibitors contemplated in accordance with the invention are, in particular, corrosion inhibitors or anticorrosion pigments. Examples of corrosion inhibitors are listed in “Corrosion Inhibitors, 2nd Edition. An industrial Guide”, Ernest W. Flick, Ed.: William Andrew Inc. ISBN: 978-0-8155-1330-8. Preferred corrosion inhibitors are hexamine, benzotriazole, phenylenediamine, dimethylethanolamine, polyaniline, sodium nitrite, cinnamaldehyde, condensation products of aldehydes and amines (imines), chromates, nitrites, phosphates, hydrazine and ascorbic acid.

Examples of anticorrosion pigments are modified zinc orthophosphates (for example HEUCOPHOS® ZPA, ZPO and ZMP), polyphosphates (for example HEUCOPHOS® ZAPP, SAPP, SRPP and CAPP), WSA-Wide Spectrum Anticorrosives (for example HEUCOPHOS® ZAMPLUS and ZCPPLUS) and modified silicate pigments (for example HEUCOSIL® CTF, Halox® 750), for example from the company Heubach GmbH, and also barium boron phosphate (for example Halox® 400), barium phosphosilicates (for example Halox® BW-111, Halox® BW-191), calcium borosilicates (for example Halox® CW-291, CW-22/221, CW-2230), calcium phosphosilicate (for example Halox® CW-491), strontium phosphosilicate (for example Halox® SW-111) or strontium zinc phosphosilicate (for example Halox® SZP-391) from the company Halox®.

Optionally the aqueous stoving paint composition may comprise one or more polyurethane dispersions (PUD) with sulfonic acid groups and/or polyethylenoxide side chains. Typical thermoplastic PUDs are prepared by reaction of polymeric diols with diisocyanate, monomeric diols or diamines, called chain extenders, and a diol-(or diamine) containing hydrophilic group. The high MW polymer chains of such polyurethane resins contain soft domains arising from polymeric polyols and hard domains from isocyanates, chain extenders and hydrophilic groups containing a diol (or diamine). Preferred for blending with the polyacrylate are PUDs where the hydrophilic group is a sulfonate moiety as described in WO9906459 and WO2003050156.

In addition it is possible to add other crosslinkers e.g. amino resins in amounts of up to 40% of total resin solids.

According to one preferred embodiment the aqueous stoving paint composition consists of
(a) the binder system (B) according to the invention
(b) one or more defoamer
(d) one or more pigments and/or fillers,
(c) optionally one or more coalescing agents
(e) optionally one or more other additives
(f) optionally one or more polyurethane dispersions with sulfonic acid groups.
   provided that any of pigments and fillers present in the aqueous stoving paint composition have a particle size of not more than 50 μm, preferably ≤30 μm, especially ≤20 μm according to DIN EN ISO 1524.

The proportion of pigments and fillers in stoving paint compositions can be described in a well-known way by the pigment volume concentration (PVC). The PVC describes the ratio of the volume of pigments (V_{P}) and fillers (V_{F}) to the total volume, consisting of the volumes of binder system (V_{B}), pigments and fillers of a dried coating film in percent:

$$PVC = ( {V}_{P} + {V}_{F} ) \times 100 / ( {V}_{P} + {V}_{F} + {V}_{B} ) .$$

The effects of the binder systems according to the invention are particularly relevant in the case of pigment-containing stoving paint compositions which have a PVC of at least 5, in particular at least 10. Preferably, the PVC will not exceed a value of 50, especially 40, and is specifically in the range from 5 to 40.

According to another preferred embodiment the aqueous stoving paint composition consists of
(a) the binder system (B) according to the invention
(b) one or more defoamer
(d) one or more pigments and/or fillers,
(c) optionally one or more coalescing agents
(e) optionally one or more other additives
(f) optionally one or more polyurethane dispersions with sulfonic acid groups, with the proviso that the stoving paint compositions has a PVC in the range from 5 to 50.

According to another preferred embodiment the aqueous stoving paint composition comprised neither any pigment nor any filler.

The content of the binder system B according to the invention in the aqueous stoving paint can be varied within wide limits. It is generally between 20 and 50 percent by weight of polymer P, based on the aqueous stoving paint composition.

According to a preferred embodiment the composition of the aqueous stoving paint is
(a) 30 to 99.9% by weight of the inventive binder system (B)
(b) 0.1 to 1% by weight of a defoamer
(c) 0 to 8% by weight of a coalescing agents
(d) 0 to 40% by weight of a pigment and/or fillers
(e) 0 to 8% by weight of other additives
(f) 0 to 30% by weight of a polyurethane dispersion with sulfonic acid groups

The aqueous stoving paint is prepared by joining the components of the composition together and making a homogeneous mixture. In the case of the presence of pigment and/or fillers, the upper particle size present in the aqueous paint is adjusted to a diameter of ≤50 μm, preferably ≤30 μm, especially ≤20 μm according to DIN EN ISO 1524 (Paints, varnishes and printing inks—Determination of fineness of grind). The adjustment of the particle size is carried out, for example, by means of grinding as described in “Paint and Surface Coatings, Theory and Practice, 2nd edition, Editors: R Lambourne and T A Strivens, Woodhead Publishing Limited, Cambrige England, 1999; page 117 ff.

The compositions of the invention do not release formaldehyde during crosslinking. Formaldehyde-free denotes that the compositions of the invention contain no substantial amounts of formaldehyde and also that no substantial amounts of formaldehyde are released in the course of drying and/or curing. In general, the compositions contain <100 ppm, preferably <10 ppm formaldehyde.

The viscosity of the binder system (at a solids content of 40% by weight) is generally in a range from approximately 10 to 4000 mPas, measured using a rotational viscometer in accordance with DIN 53019 at 23° C. and a shear rate of 250 s⁻¹.

With the stoving paint compositions, coatings can be produced on a metallic surface or a precoated metallic surface.

The disclosed aqueous stoving paint composition may be present as a layer of a mono-layer coating system or as one or more layers of a multi-layer coating system. The coating composition can be used as a primer coat, an intermediate coat, a top coat, or a combination thereof. The coating thickness of a particular layer and of the overall coating system will vary depending upon the coating material used, the substrate, the coating application method, and the end use for the coated article.

The invention further provides a method of applying a stoving paint composition to a metallic surface or a precoated metallic surface comprising
(1) applying the aqueous stoving paint composition comprising at least the binder system (B) on the metallic surface or the precoated metallic surface to form a coating layer;
   optionally drying the coating layer,
(2) thereafter curing the coating layer by treating it at a temperature in the range from 130 to 350° C., preferably 150 to 350° C.

Suitable undersurfaces are primarily pretreated, precoated (e.g. primered) or raw metallic substrates such as iron or steel, galvanised iron or galvanised steel, aluminium (or aluminium alloys) or other sheet metals like tinplate.

Preferably the metallic surface or undersurface is the surface of a metallic structure or a metal construction. Preferably the metallic surface or undersurface is the surface of buildings, engine parts, gear boxes, (food) containers, cans, power stations, chemical plants, valves, pipes, drums, fittings, flanges, couplings, roofs, and coils.

The aqueous stoving paint composition described find application in industrial coatings, primarily in the field of (interior and exterior) drum coatings, coil coating, packaging coating and automotive coatings.

The application can be carried out by the methods common in coating technology such as rolling, spraying, brushing, marbling or dipping.

The thickness of such a layer to be cured can be from 0.1 μm to 2000 μm, preferably from 1 to 2000 μm, particularly preferably from 5 to 200 μm, very particularly preferably from 5 to 60 μm (based on the material coating composition in the state in which the solvent has been removed from the material coating composition).

Drying is familiar to a person skilled in the art and is accomplished for example in a tunnel oven or by flashing off. Drying may also take place by means of NIR radiation, with NIR radiation referring here to electromagnetic radiation in the wavelength range from 760 nm to 2.5 μm, preferably from 900 to 1500 nm. Drying may take place at a temperature from ambient temperature up to 100° C. over a period of a few minutes to several days.

After drying, they can be cured in the usual manner preferably at a temperature in the range 130 to 180° C., preferably from 150 to 180° C., preferably from 140° C. to 160° C. This curing takes in general 10 to 25 minutes.

Alternatively, a higher temperature, i.e. between 20° and 350° C. (object temperature) is chosen if short curing time is desired, for example from a few seconds to a few minutes, in general from 10 seconds to 5 minutes.

Upon heating, the water in the composition evaporates and the composition cures (hardens). These processes may proceed simultaneously or in succession. By curing in this context is meant the chemical alteration of the composition; for example, crosslinking by formation of covalent bonds between the different constituents of the compositions, formation of ionic interactions and clusters, and formation of hydrogen bonds. Curing may also be accompanied by physical changes within the binder, such as phase rearrangements or phase inversions, for example. An advantage of the compositions of the invention is that they may be cured at comparatively low temperatures. The duration and temperature of heating influence the degree of cure.

The cured coating layers according to the invention possess good elasticity, good adhesion of the resulting coatings, high gloss, excellent surface hardness (non-alignment) and good water resistance and all the constituents thereof are compatible.

The invention further provides the coated metallic articles obtained by applying the stoving paint comprising the binder system B according to the invention.

The nonlimiting examples which follow are intended to illustrate the invention.

### EXAMPLES

Unless the context indicates otherwise, percentages always signify weight percent. Contents reported relate to the content in an aqueous solution or dispersion. The indication pphm (parts per hundred parts monomers) denotes the proportion by weight based on 100 parts by weight of monomer.

Where water was used in the context of the examples, demineralized water was used.

### Measurement Methods

The solids contents were determined generally by drying a defined amount of the aqueous polymer dispersion (approximately 0.8 g) to constant weight at a temperature of 130° C., using an HR73 moisture analyzer from Mettler Toledo. Two measurements are carried out in each case, and it is the average of these two measurements that is reported.

The weight-average particle sizes (Dw) were determined according to ISO 13321 using a High Performance Particle Sizer from Malvern, at 22° C. and at a wavelength of 633 nm.

The nonvolatiles content was determined from the weight loss of a 1 g sample dried at 120° C. for two hours in a circulating-air drying cabinet.

### Viscosity:

The viscosity of the compositions was determined in a Anton Paar DSR 301 at a shear rate of 250 sec-1 at 23° C. in accordance with DIN 53019.

### Example 1

### 1a) Preparation of Polymer A

A pressure reactor with anchor stirrer is charged with 0.78 kg of deionized water, 0.28 kg of maleic anhydride, and 0.22 kg of an ethoxylated oleylamine (average degree of ethoxylation=10). This initial charge is heated to 125° C. under a nitrogen atmosphere. On reaching this temperature, feed stream 1, consisting of 0.73 kg of deionized water and 0.77 kg of acrylic acid, is metered in over the course of 4 h, and feed stream 2, consisting of 0.04 kg of deionized water and 0.11 kg of H₂O₂ (30% strength by weight), is metered in over the course of 5 h, both feeds being introduced at a uniform rate. After the end of feed stream 1, a further 0.10 kg of deionized water is added. After the end of the reaction, the mixture is cooled to room temperature. The resultant aqueous polymer solution has a solids content of 43.0%, a pH of 2, and a viscosity of 450 mPas.
Weight fraction of ester (calculated): 19.7% by weight
Weight fraction of acid (calculated): 80.3% by weight

### 1b) Preparation of the Polymer P

A 4 l glass vessel with anchor stirrer (120 rpm) is charged with 335 g of water and 3% by weight of feed stream 2, and this initial charge is heated to 90° C. After 5 minutes, at this temperature, feed stream 1 is metered in over the course of 3 h and the remainder of feed stream 2 over the course of 3.5 h, the feed points being spatially separate. Subsequently, polymerization is continued at this temperature for 60 minutes and the reaction mixture is cooled.

Feed Stream 1:

| | | |
|---|---|---|
| 1978 | g | of the Polymer A from Example 1a) (43% strength by weight) |
| 595 | g | of styrene |
| 213 | g | of methyl methacrylate |
| 43 | g | of 2-hydroxyethyl acrylate |

Feed Stream 2:

| | | |
|---|---|---|
| 335 | g | of deionized water |
| 4.3 | g | of sodium peroxodisulfate |

The dispersion of polymer P prepared in this way contains 48% by weight nonvolatiles and has a pH of 2.0 and viscosity of 750 mPas.

### Example 1c) Preparation of Binder System B1

5.1 g of an aqueous solution (85% by weight) of 2,2′,2″-nitrilotriethanol (=triethanolamine) was added to 100 g of the aqueous dispersion of example 1b) and the mixture was stirred intimately. The pH of the mixture is 3.0. The viscosity of the resultant Binder system B1 is 1100 mPas.

### Example 2

### Preparation of a Binder System B2

9 g of adipic acid bis(diethanolamide) (Primid® from EMS Chemie) was added to 40 g of the dispersion prepared in Example 1b, and the mixture was stirred intimately for 20 min. Afterwards additional 60 g of the dispersion prepared in Example 1b was added. The pH of the mixture is 1.8.

### Example 3

### 3b) Preparation of Polymer P

A 4 l glass vessel with anchor stirrer (120 rpm) is charged with 258 g of water and 3% by weight of feed stream 2, and this initial charge is heated to 90° C. After 5 minutes, at this temperature, feed stream 1 is metered in over the course of 3 h and the remainder of feed stream 2 over the course of 3.5 h, the feed points being spatially separate. Subsequently, polymerization is continued at this temperature for 60 minutes and the reaction mixture is cooled.

Feed Stream 1:

| | | |
|---|---|---|
| 2002 | g | of the Polymer A from Example 1a) (43% strength by weight) |
| 440 | g | of Water |
| 301 | g | of n-butyl methacrylate |
| 517 | g | of methyl methacrylate |
| 43 | g | of 2-hydroxyethyl acrylate |

Feed Stream 2:

| | | |
|---|---|---|
| 81 | g | of deionized water |
| 4.3 | g | of sodium peroxodisulfate |

The dispersion of polymer P prepared in this way contains 47.3% by weight nonvolatiles and has a pH of 2.1 and the viscosity of 425 mPas.

### Example 3c) Preparation of Binder System B3

4.3 g of 2,2′,2″-nitrilotriethanol (=triethanolamine) was added to the 100 g aqueous dispersion of example 3b) and the mixture was stirred intimately.

### Example 4

4b) this Dispersion had been Prepared by Same Process as Example 3 but with

Feed Stream 1:

| | | |
|---|---|---|
| 2002 | g | of the Polymer A from Example 1a) (43% strength by weight) |
| 440 | g | of water |
| 34 | g | of n-butyl methacrylate |
| 375 | g | of methyl methacrylate |
| 409 | g | of cyclohexyl methacrylate |
| 43 | g | of 2-hydroxyethyl acrylate |

Feed Stream 2:

| | | |
|---|---|---|
| 81 | g | of deionized water |
| 4.3 | g | of sodium peroxodisulfate |

The dispersion of polymer P prepared in this way contains 46.4% by weight nonvolatiles and has a pH of 2.1 and Viscosity of 715 MPas.

### 4c) Preparation of Binder System B4

Subsequently, 4.3 g of 2,2′,2″-nitrilotriethanol (=triethanolamine) were added to 100 g of the aqueous dispersion of example 3b) and the mixture was stirred intimately. The pH of the mixture is 2.8, the LD 42.

### Performance Testing

### Dispersing of Pigments

Pigments were dispersed using a dissolver with a Teflon disc and 2 mm glass beads.

### Determination of Fineness of Grind

The fineness of grind was determined according to DIN EN ISO 1524 using a Hegman Grindometer. A fineness of 20 μm is considered to be good for Industrial paints.

### Gloss/Haze

The gloss of cured paint films was measured using a Byk-Instruments micro-TRI-gloss instrument according to DIN EN ISO 2813. Most films were white pigmented, dry film thickness and substrate will be provided in the context of the test results. A stoving paint with a gloss of 60 units at 60° angle is considered glossy, below 60 gloss units it is considered semi-glossy.

### Adhesion

The painted and cured sheets are tested for paint adhesion to the metal substrate using the cross-cut test according to DIN EN ISO 2409. A cross-cut test result of GT 0 is rated very good, G1 is good, GT2 acceptable.

Wet adhesion of cured paint on metal substrates was done similar to DIN EN ISO 2812-4 (Version A) using distilled water. After 24 h exposure the water was removed and immediately afterwards a cross-cut test according to DIN EN ISO 2409 was performed on the wetted area. After 24 h of recovery at room temperature the cross-cut test was repeated at another spot of the previously wetted paint film. Besides the cross-cut rating a good result is the absence of blisters (0 (S0) according to DIN EN ISO 4628-2) and rust (Ri 0 according to DIN EN ISO 4628-3).

### Film Thickness

The dry film thickness of the cured coating films was determined according to DIN EN ISO 2808 using a Eddy-current gauge.

### Hardness

The hardness of the cured coating films was measured according to DIN EN ISO 1522 (pendulum hardness according to König in oscillations). For aqueous stoving paints a hardness of above 100 osc. is considered good, above 120 osc. very good.

### Flexibility

The flexibility of the cured films on metal substrates was tested by Erichsen cupping according to DIN EN ISO 1520. The flexibility is related to the dry film thickness (DFT) and the substrate used. At a DFT of 50 μm on cold rolled steel panels (Gardobond OC) an Erichsen cupping result of 8 mm is considered good, larger than 9 mm very good.

### MEK (Methyl Ethyl Ketone) Double Rubs

The resistance against methyl ethyl ketone as a measure of chemical crosslinking and chemical resistance was measured according to ASTM D5402 (performing double rubs on the paint surface). The test has been passed if more than 200 double rubs are reached indicating a very high degree of crosslinking.

### Determination of Resistance to Liquids

This test was done according to DIN EN ISO 2812-3: filter paper was dipped into liquid substances and placed on top of the panels (horizontal orientation). At the end of the test period the filter paper was removed, and the test panels wiped dry and cleaned with water or solvents that do not attack the coating. The exposed area was immediately assed for blistering (ISO 4628-2) and visible changes to the surfaces were rated according to ISO 4628-1. A test result of 0 is considered excellent, 1-2 good, 3 acceptable, 4-5 bad.

### Application of Liquid Paint

The paints were applied by draw down (180 μm or 200 μm film applicator).

### Drying

The coated panels were flashed off for 10 min at room temperature, followed by 10 min at 80° C.

### Curing

The coated panels were heated for 20 min at 160° C. The curing process usually directly follows the drying.

### Curing at Coil Coating Conditions

The coated panels were heated for 35 seconds at a peak metal temperature of 225° C.

### Preparation of the Aqueous Stoving Paint Composition:

A white liquid paint was prepared according to the following formulation:

TABLE 1

amount [g]

Grinding paste:

| water | 2.2 | |
|---|---|---|
| Binder system B1 (Example 1c) | 11.0 | (5.28 g solid) |
| Dispex Ultra FA 4483 (from BASF; | 1.1 | (0.33 g solid) |

| dispersing agent, 30% solution) | |
|---|---|
| Foamstar PB 2724 (from BASF; defoamer) | 1.1 |
| Kronos 2310, (Titanium oxide pigment) | 21.9 |

Grind for 20 min. until a fineness of 20 μm
is reached (using 2 mm glass beads).
Let down:

| Binder system B1 (Example 1c) | 58.1 | (27.9 g solid) |
|---|---|---|
| Foamstar SI 2210 (from BASF; defoamer) | 0.2 | |
| Butyl glycol | 2.2 | |
| Halox 515 (from ICL; organic corrosion | 2.2 | |
| inhibitor) | | |
| Rheovis VP 1231 (from BASF; rheology | 0.1 | (0.03 g solid) |

| modifier, 30% solution) | |
|---|---|
| Sum | 100 |
| Solid content | 59% |

Films with a dry film thickness of approximately 50 μm were applied by draw down onto cold rolled steel panels (Gardobond OC), dried and cured.

### Application Testing Results

TABLE 2

| | |
|---|---|
| Test method | Results |

| Pendulum hardness (König) | 132 | oscillations |
|---|---|---|
| Gloss 20°/60° | 36/74 | |
| Dry adhesion: cross cut | GT0 | |
| Erichsen cupping | 9.7 | mm |

Wet adhesion

| | |
|---|---|
| Test method | Results |
| Cross cut after 24 h exposure | GT0 |
| Cross cust after 24 h recovery at room | GT0 |
| temperature | |

### Resistance to Liquids

TABLE 3

| Liquid tested | Test conditions | | Rating |
|---|---|---|---|
| FAM A Test fluid (DIN51604-1) | 15 | h 23° C. | 2 |
| FAM B Test fluid (DIN51604-2) | 15 | h 23° C. | 3 |
| B0 winter diesel (BASF) | 15 | h 23° C. | 0 |
| Bio diesel (Cas. Nr. 67762-26-9) | 15 | h 23° C. | 1 |
| Hydraulic oil (Fuchs Titan hyd Mr 530) | 15 | h 23° C. | 1 |
| Bio hydraulic oil (Fuchs Plantohyd 40N) | 15 | h 23° C. | 1.5 |
| Lube oil (Fuchs Agrifarm MOT 10W-40)) | 15 | h 23° C. | 1 |
| Bio lube oil (Fuchs Plantomot SAE 10W-40) | 15 | h 23° C. | 0 |
| Brake fluid (Fuchs Maintain DOT 4) | 4 | h 23° C. | 1 |
| radiator antifreeze (Glysantin G40) | 4 | h 23° C. | 0 |
| tar remover (EnkoClean Bitumenlöser) | 15 | h 23° C. | 1 |
| Ethanol, 48% | 1 | h 23° C. | 0 |

The coating films showed excellent chemical resistance.

### Liquid Paint Preparation Using Binder System B2

Films of binder system B2 (48% nonvolantiles by weight) were applied by draw down on aluminium panels (Q-Panel A412) to form dry films with approximately 40 μm thickness. These panels were dried and cured at coil coating conditions.

### Application Test Results

TABLE 4

| Test method | Results |
|---|---|
| Pendulum hardness (König) | 145 oscillations |
| MEK double rubs | >200 |
| Dry adhesion | GT0 |

Wet adhesion

| | |
|---|---|
| Cross cut after 24 h exposure | GT0 |
| Cross cust after 24 h recovery at room | GT0 |
| temperature | |

The clear films of binder system B2 showed good hardness, excellent adhesion and chemical resistance.

### Liquid Paint Preparation Using Binder System B3 and B4:

Films of Binder system B3 (47% nonvolatiles by weight) and Binder system B4 (47% nonvolatiles by weight) were applied by draw down onto aluminium panels (Q-Panel A412) to form dry films of approximately 30 μm thickness. These panels were dried and cured at coil coating conditions.

### Application Testing Results

TABLE 5

| | Results Binder | Results Binder |
|---|---|---|
| Test method | system B3 | system B4 |
| Pendulum hardness (König) | 124 oscillations | 127 oscillations |
| MEK double rubs | >200 | >200 |
| Dry adhesion: cross cut | GT0 | GT0 |

Wet adhesion

| | | |
|---|---|---|
| Cross cut after 24 h exposure | GT0 | GT0 |
| Cross cut after 24 h recovery | GT0 | GT0 |
| at room temperature | | |

The data in Table 5 shows excellent adhesion properties and chemical resistance of Binder systems B3 and B4.

1.-14. (canceled)

15. An aqueous stoving paint composition comprising a binder system (B), wherein said binder system (B) comprises
(a) an aqueous dispersion of polymer P, and
(b) from 1 to 10% by weight based on the amount of polymer P of at least one amine or amide having at least two hydroxyl groups,
wherein said aqueous dispersion of the polymer P is prepared by a free-radically initiated emulsion polymerization of ethylenically unsaturated monomers M
90% to 99% by weight of styrene, C₁-C₆-alkyl methacrylate, or cyclohexyl methacrylate;
1% to 10% by weight of one or more monoethylenically unsaturated carboxylic acid, hydroxy(C₂-C₄)-alkyl(meth)acrylate or glycidyl(meth)acrylate;
0% to 9% by weight of C₄-C₁₀-alkyl acrylate; and
wherein the amounts of the monomers M add up to 100% by weight,
in an aqueous medium in the presence of a polymer A, having the following monomeric structural units:

| | |
|---|---|
| 70 to 95% | of one or more ethylenically unsaturated mono- or |
| by weight | dicarboxylic acids; |
| 5 to 30% | of at least one of esters of ethylenically |
| by weight | unsaturated monocarboxylic acids, monoesters of |
| | ethylenically unsaturated dicarboxylic acids, and |
| | diesters of ethylenically unsaturated dicarboxylic |
| | acids, wherein each ester is obtained by esterifying |
| | with an amine having at least one hydroxyl group; and |
| 0 to 20% | of at least one further monomer; |
| by weight | |

the amount being based in each case on the total amount of all monomeric structural units in the polymer A.

16. The aqueous stoving paint composition according to claim 15, wherein polymer P is prepared by polymerization of the monomers M

| | |
|---|---|
| 90% to 99% | of styrene, C₁-C₄-alkyl methacrylate or cyclohexyl |
| by weight | methacrylate; |
| 1% to 10% | of one or more monoethylenically unsaturated |
| by weight | carboxylic acid, 2-hydroxyethyl acrylate or |
| | 2-hydroxyethyl methacrylate; and |
| 0% and to | of C₄-C₁₀-alkyl acrylate; |
| 9% by weight | |

wherein the amounts of the monomers M add up to 100% by weight.

17. The aqueous stoving paint composition according to claim 15, wherein polymer A has the following monomeric structural units:

| | |
|---|---|
| 70 to 95% | of acrylic acid and maleic acid, |
| by weight | |
| 5 to 30% | of at least one of esters of ethylenically |
| by weight | unsaturated monocarboxylic acids, monoesters |
| | of ethylenically unsaturated dicarboxylic acids |
| | and diesters of ethylenically unsaturated |
| | dicarboxylic acids wherein each ester is obtained |
| | by esterifying with an amine having at least one |
| | hydroxyl group, and |
| up to 20% | of at least one further monomer; |
| by weight | |

the amount being based in each case on the total amount of all monomeric structural units in the polymer A.

18. The aqueous stoving paint composition according to claim 15, wherein the structural unit of the ester of polymer A is obtained by esterifying with an amine having at least one hydroxyl group which is an alkoxylated amine.

19. The aqueous stoving paint composition according to claim 15, wherein the structural unit of the ester of polymer A is obtained by esterifying with an amine having at least one hydroxyl group which is an alkoxylated fatty amine.

20. The aqueous stoving paint composition according to claim 15, wherein the weight ratio based on solids of polymer P to polymer A is in the range from 4:1 to 1:4.

21. The aqueous stoving paint composition according to claim 15, wherein the amine has at least two hydroxyl groups.

22. The aqueous stoving paint composition according to claim 15, wherein (b) is selected from the group consisting of diethanolamine, triethanolamine, diisopropanolamine, triisopropanolamine, methyldiethanolamine, butyldiethanolamine, and methyldiisopropanolamine.

23. An aqueous stoving paint composition comprising
(a) a binder system (B) according to claim 15;
(b) one or more defoamers;
(c) optionally one or more coalescing agents;
(d) optionally one or more pigments or fillers;
(e) optionally one or more other additives; and
(f) optionally one or more polyurethane dispersions with sulfonic acid groups.

24. A method of applying a stoving paint composition to a metallic surface or a precoated metallic surface comprising
(1) applying the aqueous stoving paint composition comprising at least the binder system (B) according to claim 15 on a metallic surface or a precoated metallic surface to form a coating layer;
(2) optionally drying the coating layer; and
(3) curing the coating layer by treating it at a temperature in the range from 130 to 350° C.

25. The method according to claim 24, wherein the metallic or precoated metallic surface is the surface of metallic structures or metal constructions.

26. The method according to claim 25, wherein the metallic or precoated metallic surface is the surface of buildings, engine parts, gear boxes, (food) containers, power stations, chemical plants, valves, pipes, drums, fittings, flanges, couplings, roofs and coils.

27. The method according to claim 24, wherein the thickness of the cured stoving paint is from 0.1 μm to 2000 μm.

28. A coated article obtained by the method according to claim 24.
